(19) United States
(12) Patent Application Publication
(10) Pub. No.: US 2006/0010096 A1
(43) Pub. Date: Jan. 12, 2006

(54) Distributed application infrastructure for the purpose of ad hoc networks and intermittently connected devices

(76) Inventors: Adam Crossland, Maynard, MA (US); Greg Arzoomanian, Providence, RI (US); David Koehn, Foster City, CA (US); Peter Allen, Palo Alto, CA (US); Robert J. MacArtney, Redwood City, CA (US); Anthony A. Nassar, San Mateo, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/020,496

(22) Filed: Dec. 21, 2004

Related U.S. Application Data
(63) Continuation of application No. 10/766,572, filed on Jan. 27, 2004, now abandoned.
(60) Provisional application No. 60/442,253, filed on Jan. 27, 2003.

(51) Int. Cl. G06F 17/30

(52) U.S. Cl. 707/1

(57) ABSTRACT

A system and method to manage the distribution and monitoring of offline information on the client side. The client, once it has downloaded the content, can act as a master server to another client. The interface to the local use of the content object(s) on each client is customizable based upon the user-defined preferences or the interface design as provided by a central authority. Once downloaded, the content objects are accessed in a browser that modifies the content to ensure that it is well-behaved in an offline environment. All usage is logged in a highly structured format for reporting back to the master client, the master server, master management server, or master content repository.

### RELATED APPLICATIONS

This application is a continuation of U.S. patent application Ser. No. 10/766,572, filed on Jan. 27, 2004, entitled “Distributed Application Infrastructure for the Purpose of Ad Hoc Networks and Intermittently Connected Devices,” which claims priority from U.S. Provisional Application No. 60/442,253, filed on Jan. 27, 2003, both of which are incorporated by reference herein in their entirety.

### BACKGROUND

1. Field of the Invention

The present invention relates generally to the field of network file sharing and more particularly to a managed, distributed delivery and monitoring of information in a mobile and intermittently network-connected device.

2. Background of the Invention

The information network known as the World Wide Web (WWW), which is a subset of the well-known Internet, is arguably the most complete source of publicly-accessible information available. Through the WWW, users may retrieve or “download” data from Internet network sites and display the data that includes information presented as text, digital audio and video, graphics and the likes having appearance intended by the publisher. As the information revolution has exploded, more and more information is available through the Internet.

With today's mobile workforce growing at twice the rate of the stationary workforce, organizations are taking advantage of the flexibility and power of the Internet by placing important enterprise information on the Web for ease of access by employees and contractors, especially for the mobile workers. These highly skilled workers require secure access to large corporate digital files, and the enterprise needs to track usage of information flow to and from these workers. However, figuring out how best to store, distribute, access and update this information is a challenge for any organization. These difficulties are even greater when workers are mobile and only occasionally connected.

Managing and monitoring the delivery of information to mobile workers who may only occasionally be connected to the network is vital in many situations. For example, pharmaceutical companies may be required to prove to the FDA that their workers have reviewed rulings and other information pertaining to new products that are being brought to market. Similarly, a financial services firm may require that all information that is used by its employees to advise its customers be available for audit at any time. Also, managed and monitored delivery is needed for training applications in which knowing how information is used is just as important as ensuring that it is correctly distributed.

Commonly, organizations address the problem of managed delivery and monitoring of critical information by having staff members email files to the mobile workers with a request to confirm that they have reviewed the information. However, in such situations, there is no way to ensure that the employee has in fact reviewed the file. Moreover, email provides no means for testing that recipient's understanding of the material. Clearly, email is not effective for the management of the distribution and monitoring of information for mobile workers since there is no audit or feedback loop.

Similar faults plague the distribution of information on CD-ROMs. While CD-ROM allows the distribution of large quantities of information, there is no inherent audit or feedback capability, and organizations cannot reliably retire time-sensitive information or prevent it from being copied.

Accordingly, it is desirable to have a better means to manage the distribution and monitoring of information to mobile workers. More specifically, there is a need to easily and effectively manage the distribution and monitoring of mission critical information to workers who are only occasionally connected to the enterprise network.

### SUMMARY OF THE INVENTION

The present invention overcomes the limitations of conventional approaches to managing the distribution and monitoring of information to occasionally-connected workers by making online content available as individual objects or packages of objects in a localized, offline client environment. The system and method of the present invention continues to manage the distribution and monitoring of offline information on the client side. In addition, the client, once it has localized the content, can act as a master server to another client. The interface to the local use of the content on each client is customizable based upon the user-defined preferences or the interface design that is provided by a central authority. A search function is also provided wherein a user may request such objects from across a LAN or WAN. This configured search leverages meta-data that clarifies the use of a particular object including its ability to be localized and used while offline.

Once the content is downloaded, it is accessed through a highly-customized web browser that modifies the content to ensure that all references to online resources are redirected to the local content store. All usage of downloaded content is logged in a highly-structured XML format that can be reported back to the master server, master management server or master content repository.

### BRIEF DESCRIPTIONS OF THE DRAWINGS

FIG. 1 is an illustration of an exemplary system architecture of a system for managed delivery and monitoring of information.

FIG. 2 is an illustration of a managed delivery system for creating content packages from a variety of content objects and for tracking content packages received from a client application.

FIG. 3 is an illustration of a client application that takes content packages from a master server or a client server and tracks modification to data in the content packages.

FIG. 4 illustrates a method for managed delivery and monitoring of information according to one embodiment of the invention.

FIG. 5 is an illustration of an exemplary client application with content packages displayed.

FIG. 6 is a second illustration of an exemplary client application with an Excel content object being played.

FIG. 7 is a third illustration of an exemplary client application with a course content package being played.

FIG. 8 is an illustration of a search engine used by the client application to search for content packages on a server.

### DETAILED DESCRIPTION OF THE PREFERRED EMBODIMENTS

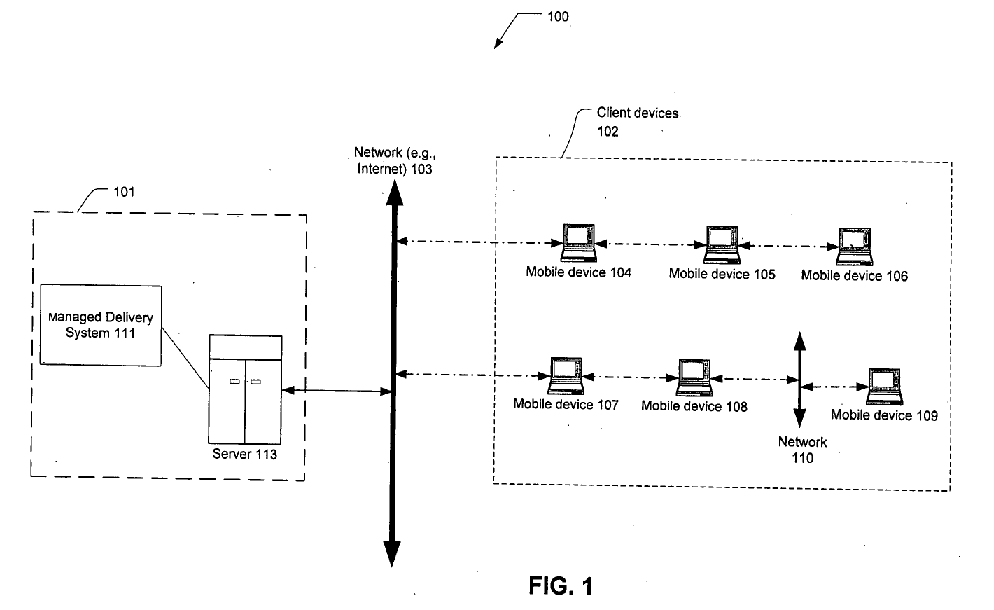

Referring now to FIG. 1, there is shown an exemplary system architecture of one embodiment of the present invention. System 100 includes an enterprise system 101 and a plurality of client devices 102. Each client device 102, as illustrated by mobile devices 104, 105, 106, 107, 108 and 109, may be a standard desktop computer, laptop computer, or a personal digital assistant such as a Pocket PC. The mobile devices include conventional operating system (e.g., Microsoft Corp.'s Windows XP, Palm OS 5), processor, memory, storage, input and output devices (including network interfaces), and so forth. Client devices 102 are configured to couple with a public network 103, such as the Internet. Moreover, each client device may be coupled to another client device (e.g., mobile device 104 is coupled to mobile device 105) or it may be coupled to another network (e.g., mobile device 108 is coupled to private network 110). The coupling of the client devices to one another or to the network 103 or the network 110 may be via Ethernet LANs, WANs, or wireless LANs (or Wireless Fidelity or Wi-Fi). In a preferred embodiment, client devices 102 are configured to intermittently couple with the network 103 and each client device may be configured to intermittently couple with another client device (e.g., mobile device 104 may be intermittently coupled to mobile device 105) or it may be intermittently coupled to another network (e.g., network 110), resulting in an occasionally connected computing (OCC) environment. Although only a limited number of client devices are illustrated in FIG. 1, those skilled in the art will recognize that any number of client devices may be coupled to the network 103 or to other client devices.

Client devices 102 may be coupled via public network 103 to a server 113 on the enterprise system 101, and may intermittently or continuously communicate with the server 103 via conventional communication protocols, e.g., TCP/IP, HTTP, CDMA, ASM, FTP, GSM, GPRS, IEEE 802.11, etc. The server 113 further includes a managed delivery system 111 for managing the delivery and monitoring of information. It is noted that the server 113 may be comprised of one or more computer systems configured to logically provide functionality as described herein.

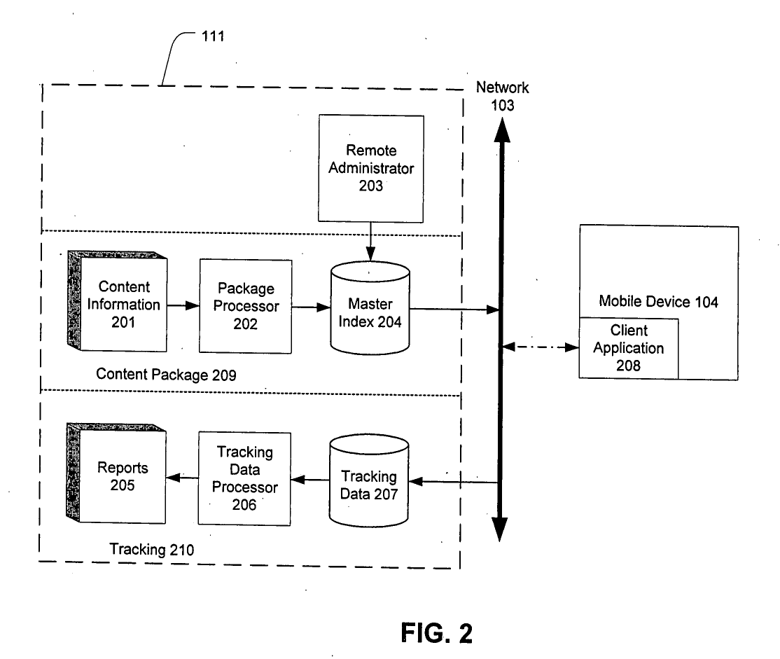

Referring now to FIG. 2, there is shown the managed delivery system 111, which includes a content package software product 209, a remote administrator 203 and a tracking software product 210. The managed delivery system 111 resides on the server 113. The client system (e.g., mobile device 104) includes a client application 208. The content package software product 209 takes original content that is to be managed and creates a directory of the files and associated preferences and controls. A package processor 202 takes managed delivery information 201 and generates a directory or master index 204 that contains a pointer to the original file plus control information. In a preferred embodiment, the master index 204 consists of a server side XML file listing of content packages for downloads by the client application 208. Once the master index 204 is created, the package processor 202 defines the information that the client application 208 on a mobile client device 104 has the rights to use. The client application software product 208 then references the master index 204 via public network 103 to get direction of what information is to be copied into the client application local environment.

The client application 208 is run by a user on the mobile device 104. The client application 208 is the place where the user operates on the information that is being managed. The client application 208 may be a plug-in for standard applications. Files are opened within the client application 208 and are referenced and reviewed. Thus, the client application 208 has viewers to display the information and records the behavior of the parts of the file that are then referenced. For example, in a training system, as the different elements of a class are reviewed, that history is placed into the tracking data file 207.

The package processor 202 bundles information 201 into a grouping (a content package) of any variety of content objects. In a preferred embodiment, this grouping is standards based, which would make the grouping interoperable with other standards based systems. In particular, the package processor 202 can take existing content files and reformat them automatically to fit the Sharable Content Object Reference Model (SCORM) standards, e.g., SCORM 1.2 standards. SCORM is a standard developed under the Advanced Distributed Learning (ADL) Initiative, sponsored by the Office of the Secretary of Defense (OSD) under a collaborative effort between government, industry and academia to establish a new distributed learning environment that permits the interoperability of learning tools and course content on a global scale. SCORM defines a Web-based learning (e-learning) Content Aggregation Model (CAM) and Run-Time Environment for learning objects. SCORM is a collection of specifications adapted from multiple sources to provide a comprehensive suite of e-learning capabilities that enable interoperability, accessibility and reusability of Web-based learning content. SCORM provides a reference model that defines the interrelationship of course components, data models and protocols so that learning content objects are sharable across systems that conform with the same model. For a further discussion of SCORM standards, please refer to Sharable Content Object Reference Model (SCORM) Version 1.2, Advanced Distributed Learning 2002, and SCORM version 1.2 Conformance Requirements Version 1.2, Advanced Distributed Learning 2002, which are incorporated by reference herein.

Content objects may consist of HTML pages, digital media (such as MPEG movies, Quicktime video, MP3 audio, WAV audio), static graphical images, word processor documents, spreadsheets, slideshow presentations, Adobe Acrobat files, databases, etc. A content package is a grouping of any variety of content objects and may, for example, include objects grouped for an e-learning course, a catalog, or a manual. In a preferred embodiment, the package processor 202 can wrap any set of content objects into content packages, consisting of an XML service wrapper, for indexing in the master index 204.

The CAM specification of the SCORM standards allows learning content to be put together so it can be moved and reused. The first specification in CAM is Learning Object Metadata, which is a dictionary of tags that are used to describe learning content in a variety of ways. Learning Object Metadata describes policies such as what the content is, who owns it, technical requirements, educational purpose, etc. The second specification in CAM is the XML binding for metadata tags. This defines how to code the tags in XML so they are machine-readable. The third specification in CAM is the IMS Content Packaging specification, which defines how to package together a collection of learning objects, their metadata, and information about how the content is to be delivered to the client application 208.

The package processor 202 not only creates XML files that describe content packages and aggregates the objects for delivery to the client application 208, but also associates metadata (policies) with the content package bundle. The types of metadata that can be associated with content packages are flags such as an expiration date, a release date, a flag to encrypt the content, a setting to compress the content, and so forth. It is noted that policies travel with the content package. The master index 204 provides ease of integration and the list of content packages available for download by the client application 208, and the master index 204 also sets the policies associated with a content package.

The tracking software product 210 provides a single unified graphing and reporting environment to evaluate tracking data 207 that has been sent back from the mobile device 104 using the client application 208. A tracking data processor 206 takes the history of the use of the information from the tracking data 207 and generates various reports necessary to satisfy compliance or audit of the managed information. Tracking data can include any data in a content package that the tracking software 210 monitors or manages, such as training courseware data, financial audit data, forms, manuals, video or audio data files, etc.

The remote administrator 203 is coupled to the content package software product 209. The remote administrator 203 gives an enterprise administrator the ability to change the user and access rights on remote machines using the client application 208. The remote administrator 203 can modify the tables that map users to passwords, machines, and repositories. For example, if there is no expiration date, the remote administrator 203 can reset the policy to provide a date and time when the content object will expire. In addition, the remote administrator 203 can update the usernames and passwords on any remote machine using the client application 208. The remote administrator 203 can also disable the entire client application 208 or update the version of the client application 208 remotely. Thus, remote administrator 203 can adjust and manage policy at the user account level and at the application level.

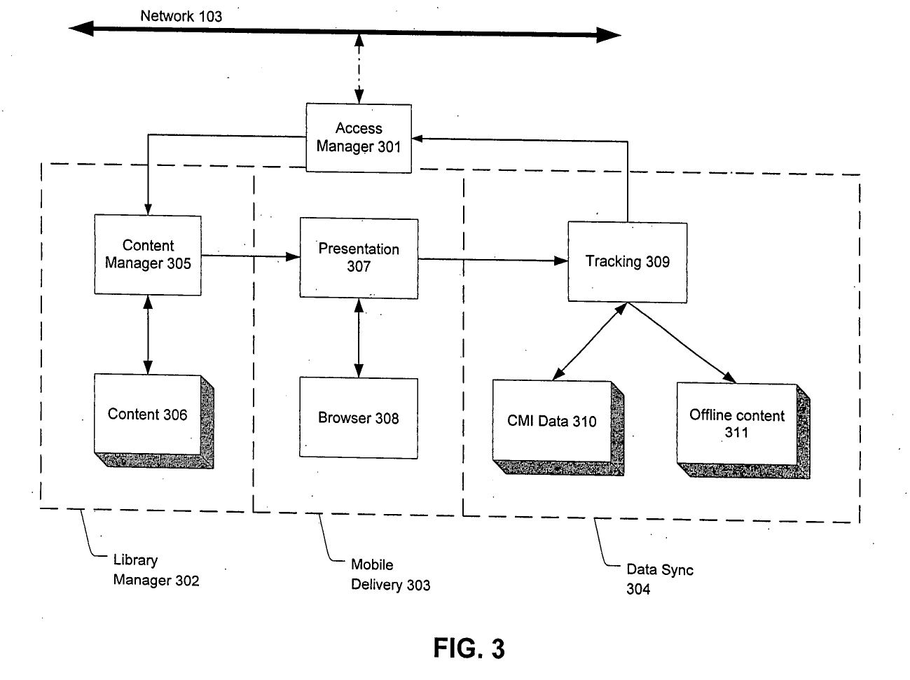

Now referring to FIG. 3, there is shown the client application 208, which includes an access manager 301, a library manager 302, a mobile delivery engine 303 and a data sync engine 304. The client application 208 allows for the management of documents and files (in content packages) by mobile clients. In a preferred embodiment, the client application 208 is a universal client that is browser-based (e.g., a conventional browser such as Microsoft Corp.'s Internet Explorer or Netscape Navigator), and provides for a client-centered solution. In a preferred embodiment, the client application 208 extends standards-based (i.e., complying with SCORM 1.2 standards) content to mobile users in an occasionally connected computing environment.

The client application 208 can operate independently of the server 113. That is, the client application 208 is a client-centered solution, and no server-side software product is required to manage and control the use of information in content packages referenced by the client. Instead, once the master index 204 is created, a mobile user uses the client application 208 to review the information locally without direction or communication with the server 113. The access manager 201, which is coupled to the network 103, manages the downloading and uploading of content packages from the server-side platform (from the master index 204) in an occasionally-connected computing environment.

Because the client application 208 is a client-centered solution, the client application 208 can also broker a content package from another client application residing on another client device (e.g., a client application on mobile device 105 can broker a content package from a client application on mobile device 104). Thus, a client application can download a content package from the server 113 (a master server) or from another client application running on another client device (a client master). In this manner, content packages can be discovered across multiple servers, clients and networks (as illustrated in FIG. 1) as available individual objects or packages of objects and then localized for offline or low bandwidth use without the loss of the run time reads and writes usually associated with content objects used in an online scenario.

The client, once it has localized the conformant object, can act as a client master to another client. The client application 208 on a client announces itself to other client applications on other clients on the network that have both a secured handshake and that the machine to machine connection is part of the same network, and that the user permissions (and other policies associated with access) permit the specific object, package, set of packages, or policies to move between the users and/or machines. For example, client application 208 on mobile device 104 can communicate with a client application running on mobile device 105 by announcing itself to the other client using a secured handshake and following the policies associated with the access.

Once a client announces to another that it is secure and available and the announcement has been received/accepted/acknowledged/approved then the secondary (child) client application requests the package and policy associated with that package across the available network provided by the announcement. The network may be the same or different than the network used to deliver the announcement.

In one implementation, UDDI broadcast detects can be used for announcement and availability in connection with “presence,” and the HTTP can be used for secure authentication. Then FTP can be used to transition the object form one instance of a user's account in a client application to another.

Tracking information proceeds back up the child parent network based on the policies associated with availability and trusted parenthood. Tracking information and offline submissions from the child to the parent or to the master server can be automated, policy driven, or chosen manually by the user.

In the preferred embodiment, the client application 208 will communicate to other platforms to begin content brokering in a hybrid Peer to Peer (P2P) fashion. In an embodiment, the client application runs a custom server to make the browser 308 think that it is online. This same client server can ping and receive private messages over a LAN to announce its presence and for a hybrid P2P network to form. UDP messages may be used for download, exit or entry of content network membership. Content brokering is thereafter achieved via conventional protocols, such as HTTP, HTTPS, or FTP protocols.

Once the hybrid P2P network is instantiated, one (or more) client application acts as the brokering host. It essentially becomes a content server and feedback repository for other client applications on other clients in the local autonomous network, much like the backend content server and transaction stores that the brokering host originally needed/used to receive its content library. This ability for the client application 208 to broker content (and relay transactions) into an otherwise unreachable or inconvenient autonomous network extends the control, use, compliance, and productivity of vital information.

The interface to the local use of the content packages on each client is customizable based upon the user-defined preferences or the available interface design provided by a central authority. Data integrity required by the managed delivery and monitoring of information in an occasionally-connected environment is maintained since each content package has metadata associated with it. The metadata stays with the content package as it is moves from one client application to another. Thus, as a content package is downloaded by a client application on mobile device 105 from a client application on mobile device 104, metadata remains with the content package to manage and monitor the information. Hence, the tracking of information usage remains with each content package as it is transferred from the server 113 or from one client application to another.

For security, the access manager 201 will only broadcast or detect unique user IDs that it recognizes. Moreover, a content package may have a metadata tag in its policy to indicate an expiration date, and expired content is removed from the system. A content package may also have an encryption tag associated with its policy that allows the package to only be played in the client application 208. A content package may also have a tag for password protection in its policy. Those skilled in the art will recognize that other metadata may be associated with a content package for security purposes.

The access manager 301 is coupled to the service library 302 via the content manager 305. The library manager 302 maintains the content packages available to the user. The content manager 305 takes content packages that are downloaded by the access manager 301, stores the content packages in the content module 306, and manages the content packages.

The mobile delivery engine 303 is coupled to the library manager 302 via the presentation module 307. In a preferred embodiment, the mobile delivery engine 303 uses a user interface that is managed by a Web application, which provides the framework in which the content packages play. The mobile delivery engine 303 interacts with the library manager 303 to retrieve content packages and deliver it to the user's Web browser 308. The browser 308 is a convention Web browser such as Microsoft Corp.'s Internet Explorer or Netscape Navigator. The presentation module 307 manages and prepares the content package to be played on the browser 308. In an alternative embodiment, a pluggable user interface can also be used to play the content packages.

The mobile delivery engine 303 is coupled to the data sync engine 304 via the tracking module 309. The data sync engine 304 is responsible for synchronizing (or syncing) the Computer Managed Instruction (CMI) data 310 and the offline content 311 between individual installations of the client application 208 and the tracking software product 210 via network 103. In an alternative embodiment, data sync engine 304 can also sync the CMI data 310 and the offline content 311 with another client application on different client device. CMI data is SCORM Run-Time Environment (RTE) Data that enables tracking and monitoring of content packages. CMI data contains a set of services that launches learning content, keeps track of learner progress, determines the sequence in which learning objects are to be delivered, and reports student mastery of a learning experience. In a preferred embodiment, the client application 208 implements the entire SCORM 1.2 RTE API and supports all elements of the RTE Data Model. Thus, when connected to the network 103, the tracking module 309 enables the access manager 301 to upload all modified data in the RTE Data Model to the tracking software product 210 by binding all modified data into the XML format (defined in the SCORM interface) and uploads it via FTP or via HTTP posts or SOAP messages.

The mobile delivery engine 303 thus intelligently records all information in the content packages that is designated to be monitored. Moreover, forms can be completed offline and stored in the offline content cache 311. Completed forms are uploaded to the tracking software product 210 when network connection is established.

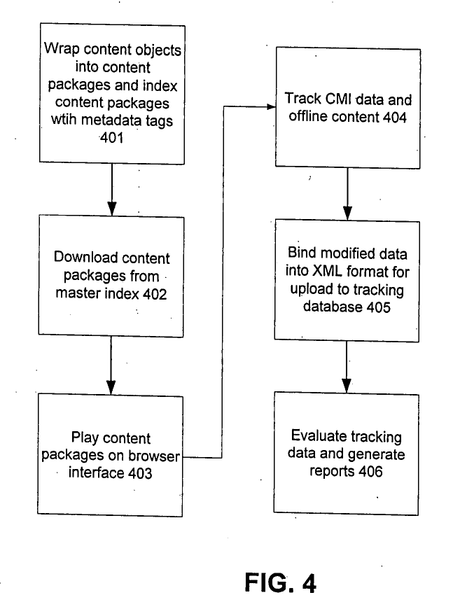

Now referring to FIG. 4, there is shown an embodiment of a method for managed delivery and monitoring of information. The content package 209 on the server 113 takes an original content that is to be managed and creates a directory of the files and associated preferences and controls. The package processor 202 wraps content information 201 into content packages with associated metadata tags, and the content packages are listed in the master index 204, step 401. The access manager 301 of the client application 208 can then search and download the content packages from the master index 204, step 402. The content packages are stored and managed by the library manager 302 in the client application 208. The mobile delivery manager 303 can then retrieve the stored content packages from the library manager and executing (or playing) the content packages in a browser interface, step 403. The data sync manager 304 monitors and tracks the CMI data and offline content, step 404. The tracking module 309 of the data sync manager 304 then binds (or wraps) modified data into XML for uploading into the tracking database system 210 on the server 113, step 405. The tracking data processor 206 then evaluates tracking data and generate reports responsive to the modified data, step 210.

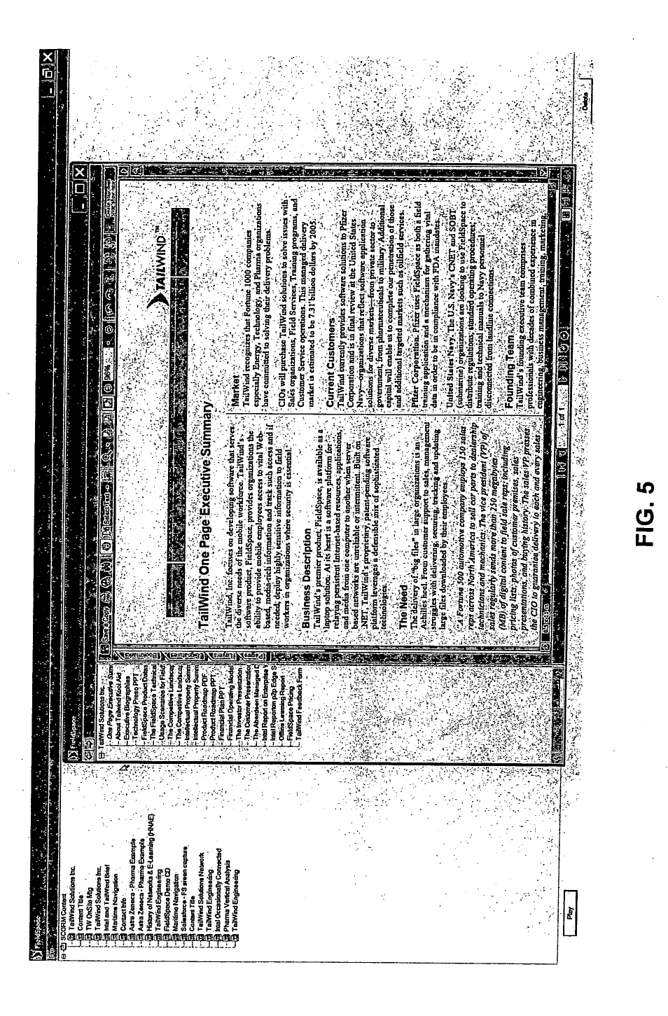

FIGS. 5-8 illustrates exemplary aspects of the present invention. FIG. 5 illustrates the client application 208 with various SCORM content packages downloaded to the library manager 302, e.g., TailWind Solutions, Inc. content package, Content Title content package, TW OnSite MTG content package, etc. The TailWind Solutions, Inc., content package is displayed by the browser 308 in further detail with various content objects revealed. In particular the browser 308 plays the “One Page Executive Summary” content object.

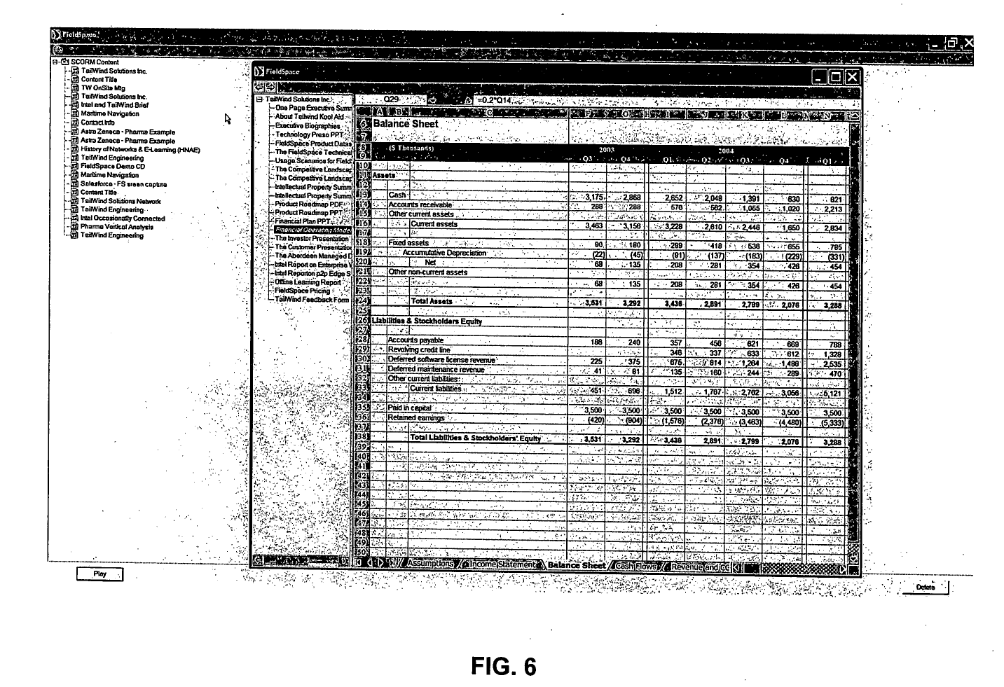

FIG. 6 is identical to the illustration in FIG. 5 except that here, the “Financial Operating Model” content object is being played. Changes made to this Microsoft Excel content object is tracked by the data sync manager 304 for later upload to the tracking database system 210 on the server when network connection is re-established.

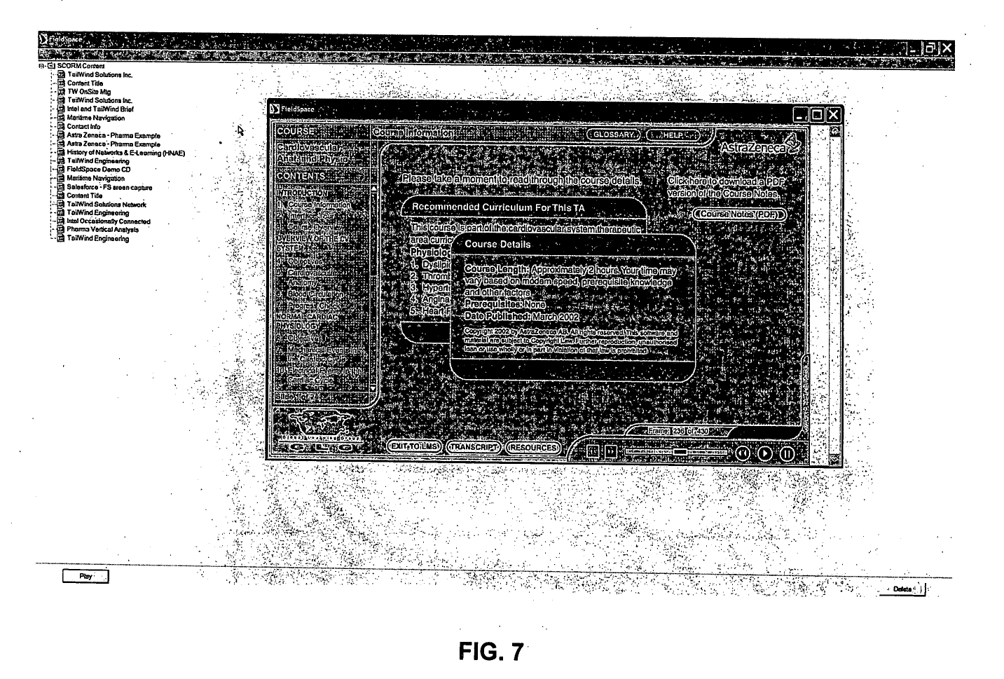

FIG. 7 illustrates a course content package that is being played on the browser 308 in the client application 208. Again, the data sync manager 304 will track the user's progress in the course and update the tracking database system 210 on the server when network connection is re-established.

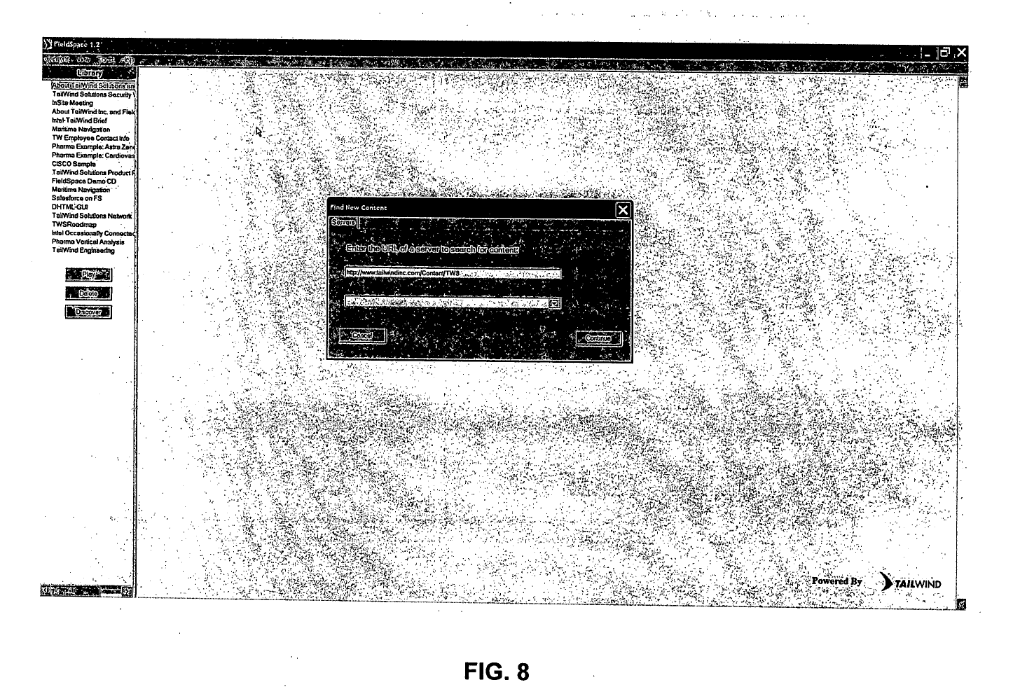

FIG. 8 illustrates a search engine on the client application 208 that is used to search for content packages on network server.

### Examples of Managed Delivery and Monitoring of Information for the System 100

In many instances, the use of a distributed application infrastructure to solve immediate problems with accountability and tracking of human capital can be solved using the managed delivery and monitoring system 100.

Pharmaceuticals

A large pharmaceutical company leverages trackable knowledge objects. This pharma company has high requirements for all of its field-based employees to understand the extensive and detailed minutiae of a wide array of products. Currently, the solution involves tethered learning, sitting in the office and clicking through pages after page of e-learning.

The field representative unplugs his laptop halfway through because he has to get on a plane to visit a customer site. Currently, the e-learning system cannot go with him.

When connected to the network 103, the field representative can download to his laptop (e.g., using the client application 208 on the mobile device 104) the training courseware content package from the master index 204 on the content package software product 209 residing on server 103. Once the training courseware content package is downloaded onto his laptop, he can take his sales support training courseware with him. Also, he will use it as part of his sales pitch using the knowledge at the point-of-activity—in the sale. The use of the different parts of the materials will be tracked.

Fortunately, when a connection is re-established, the pieces of content used and the user's experience with that content—such as timing, duration, performance, hits, are all passed back to the company's central repository by the tracking software product 210. The sales representative's user experience is tracked in the CMI data 310 in the client application 208. The tracking module 309 will bind any modified data into metadata associated with the training courseware content package. When connection is reestablished, the client application 208 can then upload the modified training courseware content package into the tracking data 207. The tracking software package 205 will process and track changes in the training courseware content package and pass the user's experience with the training courseware back to the company's central repository.

If the sale is successful, the content objects used can be compared to those used by a salesman in an unsuccessful sale. The tracking software product 210 can track which objects are used in successful sales and deprecate objects never used or that do not lead to sales.

Other sale representatives can also download the training courseware content package from one client device to another. For example, the same training courseware content package as described above can be downloaded by a second sale representative onto a second laptop running a client application (e.g., sale representative two using mobile device 105 can download the training courseware content package from sale representative one using mobile device 104). The policies associated with the training courseware content package will travel with the content package. Thus, the user's experience of the second sale representative will also be monitor and tracked in the metadata associated with the content package.

The Military's Need

The armed forces are the most training-intensive organizations in the world. The problem with their workforce is that it often does not work in an office; it is highly mobile. The military has some very specific problems that are solved by system 100. They have a land-based server full of content that needs to be replicated out to a slave server in a remote field. They then need to vend that content out to individual workstations, occasionally-connected laptops, and other untethered devices. All of this content needs to be replicated and vended while the built-in tracking data is simultaneously followed through the system.

For example, a user accesses a content object, such as a diagram, in the classroom on board a ship at sea. This access is tracked for reporting back to the user's profile. Additionally, that diagram is delivered to a mobile device so that the user, while executing multiple tasks around the ship, can quickly access the diagram he needs to complete a repair in short order. The use of that object on that device in that instance is reported back to the user's profile. An officer can have a dashboard view into the use of information across the ship. Once the ship docks and a network connection is re-established, all the tracking data is reported back to the network where another officer can see a dashboard view into the use of content objects across the entire fleet.

Field Services

A copier repairman is trained in the office to repair ten different types of copiers. The manuals sit in his office while he is out in the field. Getting those manuals into his hands in a searchable, compressed, and tracked format will increase his efficiency.

Furthermore, associating the content objects via metadata with his service call systems will automate the provisioning of content. The device will know what machine he is scheduled to be working on and what might be wrong with the machine, readily loading a procedure or diagram on-the-fly based on the metadata.

Since the system has a history of the person, even while he is offline, the system can play back a customized version of the content. The system 100 will enable this long-term view.

Associated with that event will be a feedback loop, so if the diagram or procedure is wrong, the repairman will post a message associated with that object. The caveat will follow the object until it is reviewed and a change can be integrated into the content object.

Environmental, Industrial Hygiene and Safety Markets

On-site safety consideration is a high-level issue with every nuclear power plant, construction project, dumpsite and other field-based environments. The field-based safety engineer is always on the road at remote sites. Occasionally, they are asked to return to the training center to be updated on changes to existing regulations and the addition of new ones. What if that certification process was not a gate event but a system of supplying the knowledge needed to assess a situation in an on-demand and on an as needed basis? With the system 100, the local set of workers can share content and load needed information on an ad-hoc basis.

Energy

Remote Alaska, Platform Drilling and Central Africa are examples of locations that demand maximum leverage from a limited supply of human capital.

In remote locations, robust, trackable, redundant information that is a seamless extension of the corporate manifest for the operation creates a network by which large organizations can attest to their commitment to integrity in the field.

The present invention uniquely enables remote field workers to increase their skills, rehearse the expected competencies, and learn about new technologies.

The Publishing House

Knowledge networks can enable publishing houses to dramatically extend their reach to their customers. The present invention can serve as the backbone for a new system of delivering information; by delivering over the Internet to occasionally-connected computers and charging on a pay-per-use basis, a publishing house can not only increase the volume of its business but also better serve its customers and increase their brand loyalty.

Regardless of whether the application charges a subscription fee, or has a pay-per-use or ownership model, system 100 is the initial step towards realizing this publishing house network. The content package serves as the next-generation publishing control function; each page of content can be tracked as it is used, enabling an entirely-new, interactive, intelligence experience.

The above description is included to illustrate the operation of the preferred embodiments and is not meant to limit the scope of the invention. The scope of the invention is to be limited by only the following claims. From the above discussion, many variations will be apparent to one skilled in the relevant art that would yet be encompassed by the spirit and scope of the invention.

We claim:

1. A computer implemented method for managed delivery and monitoring of information in an occasionally-connected computing environment comprising:
receiving on a client computer a content package, wherein the content package comprises at least one content object and wherein a policy is associated with the content package;
executing the content object on a user interface;
tracking data that have been modified in a content object responsive to the policy associated with the content package; and
binding the modified data into the policy associated with the content package.

2. The method of claim 1 further comprising uploading the bound modified data to tracking database on a server.

3. The method of claim 2, wherein the tracking database generates a report responsive to the modified data.

4. The method of claim 2, wherein the tracking database updates content on the server responsive to the bound modified data.

5. The method of claim 1, wherein the steps of playing, tracking and binding are performed on a client computer.

6. The method of claim 5, wherein the user interface plays the content object while the client computer is offline.

7. The method of claim 5, wherein the tracking step is performed while the client computer is offline.

8. The method of claim 5, wherein the binding step is performed while the client computer is offline.

9. The method of claim 5, wherein the client computer interconnects with a server via a communication network.

10. The method of claim 9, wherein the communication network is the Internet.

11. The method of claim 9, wherein the client computer interconnects with a server via a wireless LAN.

12. The method of claim 9, wherein the client computer interconnects with a server via a WAN.

13. The method of claim 1, wherein the content package is downloaded from an index database on a server.

14. The method of claim 1, wherein the content package is in an XML format.

15. The method of claim 1, wherein the user interface is a web browser.

16. The method of claim 1, wherein the policy is a metadata tag.

17. The method of claim 1, wherein the policy comprises an expiration flag for the content package.

18. The method of claim 1, wherein the policy comprises an encryption flag for the content package.

19. The method of claim 1, wherein the policy comprises password protection for the content package.

20. The method of claim 1, wherein the modified data are tracked in a SCORM RTE data model.

21. The method of claim 1, wherein the content package is wrapped in a SCORM-compliant content package.

22. The method of claim 1 further comprising uploading the content package to a second client computer.

23. The method of claim 1 further comprising searching for the content package on a server from the client computer.

24. A computer implemented system for managing delivery and monitoring of information in an occasionally connected computing environment comprising:
an access manager on a client computer for downloading and uploading a content package, wherein a content package comprises at least one content object and wherein a policy is associated with the content package;
a library manager for storing the content package;
a mobile delivery manager for extracting the content object from a content package and playing the content object on a user interface; and
a data sync manager for tracking modified data in the content package responsive to the policy associated with the content package and binding the modified data to the policy associated with the content package.

25. The system of claim 24 further comprising a tracking database on a server for receiving the bound modified data.

26. The system of claim 25, wherein the tracking database generates a report responsive to the bound modified data.

27. The system of claim 24, wherein the access manager downloads the content package from an index database on a server.

28. The system of claim 24, wherein the access manager uploads the content package to a second client computer.

29. The system of claim 24, wherein mobile delivery manager extracts and plays the content package while offline.

30. The system of claim 24, wherein the data sync manager tracks and binds the modified data while offline.

31. The system of claim 24, wherein the client computer interconnects with a server via a communication network.

32. The system of claim 31 further comprising a search engine on the client computer for searching the content package on a server.
